(19) United States
(12) Patent Application Publication
(10) Pub. No.: US 2023/0238731 A1
(43) Pub. Date: Jul. 27, 2023

(54) CONNECTOR UNIT

(71) Applicants: AUTONETWORKS TECHNOLOGIES, LTD., Mie (JP); SUMITOMO WIRING SYSTEMS, LTD., Mie (JP); SUMITOMO ELECTRIC INDUSTRIES, LTD., Osaka (JP)

(72) Inventors: Nungna WI, Mie (JP); Shinji NOZAKI, Mie (JP)

(21) Appl. No.: 18/007,880

(22) PCT Filed: May 19, 2021
(86) PCT No.: PCT/JP2021/018891

§ 371 Date: Dec. 2, 2022

(30) Foreign Application Priority Data
Jun. 8, 2020 (JP) 2020-099366

(51) Int. Cl. H01R 13/506; H01R 13/514; H01R 13/639

(52) U.S. Cl. CPC H01R 13/506; H01R 13/514; H01R 13/639

(57) ABSTRACT

This connector unit 1 is provided with a plurality of coupled sub connectors 10, wherein the sub-connectors 10 are each provided with a lower housing 20 and an upper cover 40, and the upper cover 40 is configured to be slidable between a main closed position and a provisional closed position and to be pivotable between the provisional closed position and an open position. One among the lower housing 20 and the upper cover 40 comprises: a pivoting permitted part 51A that permits pivoting when the upper cover 40 is at the provisional closed position; and a pivoting restriction part 51B that restricts pivoting when the upper cover 40 is at the main closed position. One sub connector 10A is provided with a movement restriction part 45 that restricts a slide movement of the upper cover 40 provided to another sub connector 10B from the main closed position to the provisional closed position.

### TECHNICAL FIELD

The technique disclosed by this specification relates to a connector unit.

### BACKGROUND

A connector is known which includes a base portion (lower housing) for holding a terminal and a cover for covering the terminal by being assembled with the base portion. The cover is assembled with the base portion rotatably between an opening state and a closing state. When the cover is in the opening state, the terminal accommodated inside the base portion is exposed. When the cover is in the closing state, the terminal is covered by the cover (Patent Document 1).

### PRIOR ART DOCUMENT

### Patent Document

Patent Document 1: JP 2019-192636 A

### SUMMARY OF THE INVENTION

### Problems to be Solved

There is a request for using a plurality of connectors as described above as one connector unit by coupling the plurality of connectors. In such a case, if an unexpected force is applied to the cover for a certain reason and the cover is opened during an assembling operation of the connector unit with another member or during use, it may pose a problem for the assembling operation or use.

### Means to Solve the Problem

A connector unit disclosed by this specification is a connector unit with a plurality of coupled sub-connectors, the sub-connector includes a terminal, a lower housing having an opening, the lower housing accommodating the terminal, and an upper cover to be assembled with the lower housing to close the opening, the upper cover is slidable between a complete closing position for closing the entire opening and a temporary closing position shifted from the complete closing position and rotatable between the temporary closing position and an opening position for opening the opening, one of the lower housing and the upper cover includes a rotation allowing portion for allowing rotation of the upper cover to the opening position when the upper cover is at the temporary closing position and a rotation restricting portion for restricting the rotation of the upper cover to the opening position when the upper cover is at the complete closing position, and one sub-connector, out of the plurality of sub-connectors, includes a movement restricting portion for holding the one sub-connector inseparably from another sub-connector by being engaged with the other sub-connector and restricting a sliding movement of the upper cover provided in the other sub-connector from the complete closing position to the temporary closing position.

### Effect of the Invention

According to the connector unit disclosed by this specification, the upper cover can be restricted from being opened and it can be avoided to pose a problem for an assembling operation and use by a simple configuration.

### BRIEF DESCRIPTION OF THE DRAWINGS

FIG. 1 is a perspective view of a connector unit of an embodiment.

FIG. 2 is a perspective view of a sub-connector of the embodiment.

FIG. 3 is a plan view of the sub-connector of the embodiment.

FIG. 4 is a section along A-A of FIG. 3.

FIG. 5 is a side view of the sub-connector of the embodiment.

FIG. 6 is a side view of the sub-connector in a state where an upper cover is at a temporary closing position.

FIG. 7 is a section along A-A of FIG. 3 of the sub-connector in the state where the upper cover is at the temporary closing position.

FIG. 8 is a side view of the sub-connector in the state where the upper cover is at an opening position.

FIG. 9 is a section along A-A of FIG. 3 of the sub-connector in the state where the upper cover is at the opening position.

FIG. 10 is a perspective view of a lower housing of the embodiment.

FIG. 11 is a perspective view of the upper cover of the embodiment.

FIG. 12 is a side view of the upper cover of the embodiment.

FIG. 13 is a perspective view of a joint terminal in a state where a slide member is at a partial locking position in the embodiment.

FIG. 14 is a side view of the joint terminal in the state where the slide member is at the partial locking position in the embodiment.

FIG. 15 is a section along A-A of FIG. 3 of the lower housing having the joint terminal accommodated therein in the embodiment.

FIG. 16 is a back view of the connector unit of the embodiment.

FIG. 17 is a side view of the connector unit of the embodiment.

FIG. 18 is a section along A-A of FIG. 3 showing a state where the connector unit of the embodiment is connected to a mating member.

FIG. 19 is a perspective view of a connector unit of a modification.

FIG. 20 is a perspective view of a sub-connector in a state where an upper cover is at an opening position in the modification.

FIG. 21 is a section along A-A of FIG. 3 of the sub-connector in a state where the upper cover is at a complete closing position in the modification.

### DETAILED DESCRIPTION TO EXECUTE THE INVENTION

### Description of Embodiments of Present Disclosure

(1) The connector unit disclosed by this specification is a connector unit with a plurality of coupled sub-connectors, the sub-connector includes a terminal, a lower housing having an opening, the lower housing accommodating the terminal, and an upper cover to be assembled with the lower housing to close the opening, the upper cover is slidable between a complete closing position for closing the entire opening and a temporary closing position shifted from the complete closing position and rotatable between the temporary closing position and an opening position for opening the opening, one of the lower housing and the upper cover includes a rotation allowing portion for allowing rotation of the upper cover to the opening position when the upper cover is at the temporary closing position and a rotation restricting portion for restricting the rotation of the upper cover to the opening position when the upper cover is at the complete closing position, and one sub-connector, out of the plurality of sub-connectors, includes a movement restricting portion for holding the one sub-connector inseparably from another sub-connector by being engaged with the other sub-connector and restricting a sliding movement of the upper cover provided in the other sub-connector from the complete closing position to the temporary closing position.

According to the above configuration, the sliding movement of the upper cover of the other sub-connector from the complete closing position to the temporary closing position is restricted by the movement restricting portion of the one sub-connector. Since the rotation to the opening position is restricted with the upper cover located at the complete closing position, it is avoided during an assembling operation with another member or during use that the upper cover is opened to pose a problem for the assembling operation or use. Further, since the movement restricting portion has both a function of holding the one sub-connector on the other sub-connector and a function of restricting a movement of the upper cover, a configuration is simplified.

(2) One of the upper cover and the lower housing may include a shaft portion and the other may include a shaft hole for receiving the shaft portion, a part of the shaft hole may serve as the rotation allowing portion for rotatably accommodating the shaft portion when the upper cover is at the temporary closing position and another part of the shaft hole may serve as the rotation restricting portion for accommodating the shaft portion while restricting the rotation when the upper cover is at the complete closing position, and the movement restricting portion of the one sub-connector may be accommodated into the rotation allowing portion of the other sub-connector.

According to this configuration, since the shaft hole can be used as the rotation allowing portion and the rotation restricting portion, it is not necessary to separately provide a configuration for restricting the rotation of the upper cover and the configuration is simplified.

(3) The connector unit may further include a lock member to be assembled with the other sub-connector, and the lock member may include a lock arm having a lock portion to be engaged with a mating member, the lock arm being deflectable in a releasing direction for releasing engagement of the lock portion with the mating member, and a deflection restricting portion connected to the lock arm, the deflection restricting portion restricting deflection of the lock arm in a direction opposite to the releasing direction by being engaged with the movement restricting portion provided in the other sub-connector.

According to the above configuration, since the movement restricting portion can be used also to restrict the deflection of the lock arm, the sub-connector needs not be separately provided with a configuration for restricting the deflection of the lock arm and the configuration is simplified.

### Details of Embodiment of Present Disclosure

A specific example of the technique disclosed by this specification is described below with reference to the drawings. Note that the present invention is not limited to these illustrations and is intended to be represented by claims and include all changes in the scope of claims and in the meaning and scope of equivalents.

### Embodiment

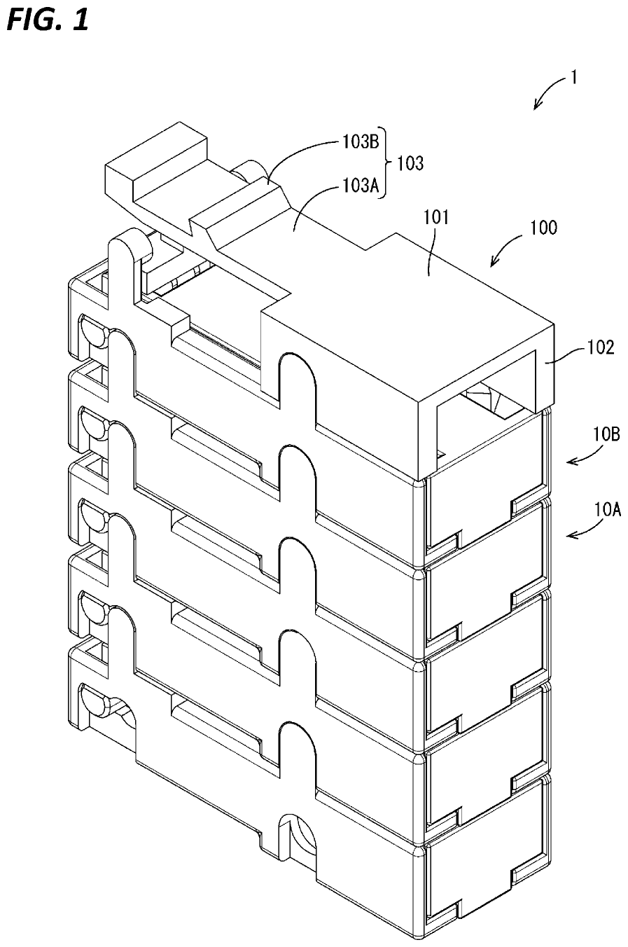

An embodiment is described with reference to FIGS. 1 to 18. A connector unit 1 of this embodiment is, as shown in FIG. 1, provided with a plurality of (five in this embodiment) stacked sub-connectors 10 and a lock member 100 to be assembled with the sub-connector 10 located on an end, out of the plurality of sub-connectors 10. This connector unit 1 is accommodated into a receptacle 111 of a mating member 110 as shown in FIG. 18.

### Overall Configuration of Sub-Connector 10

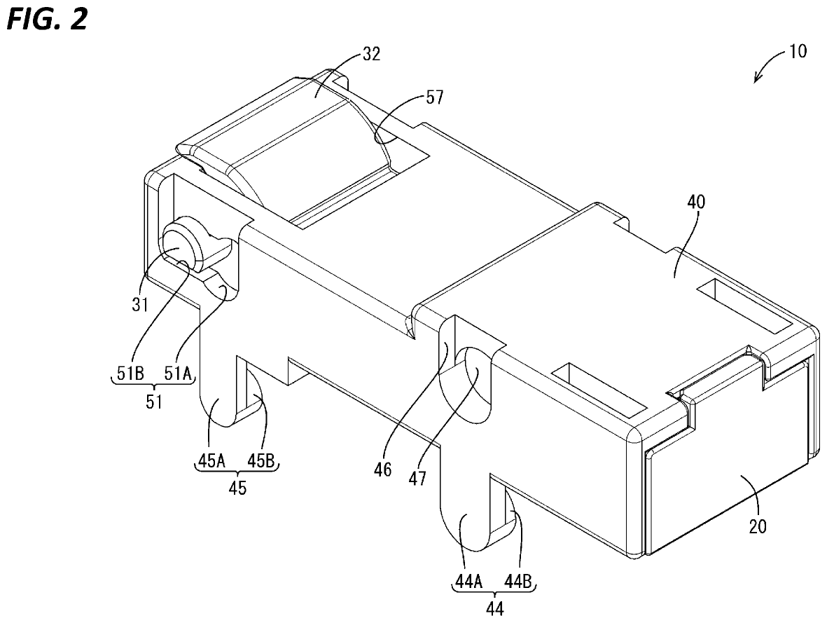

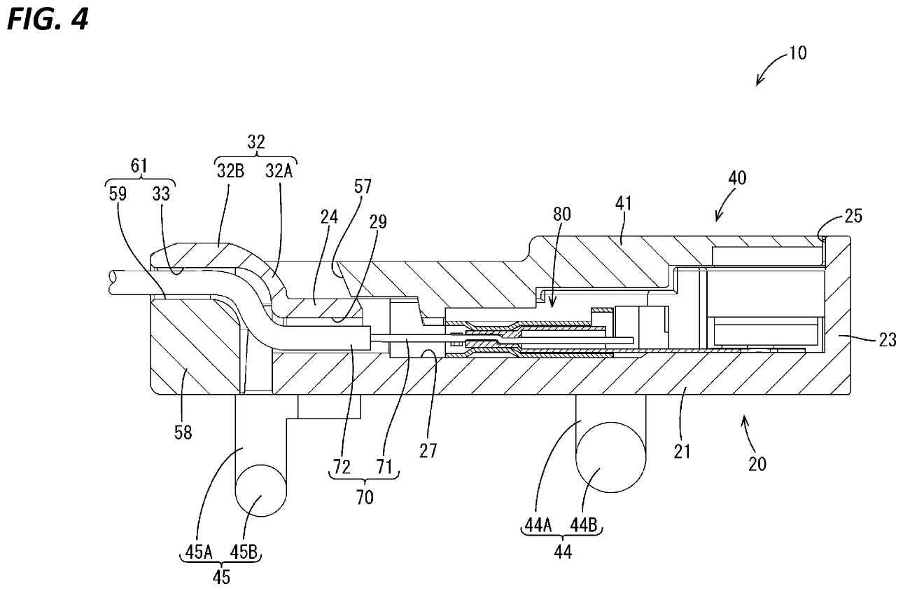

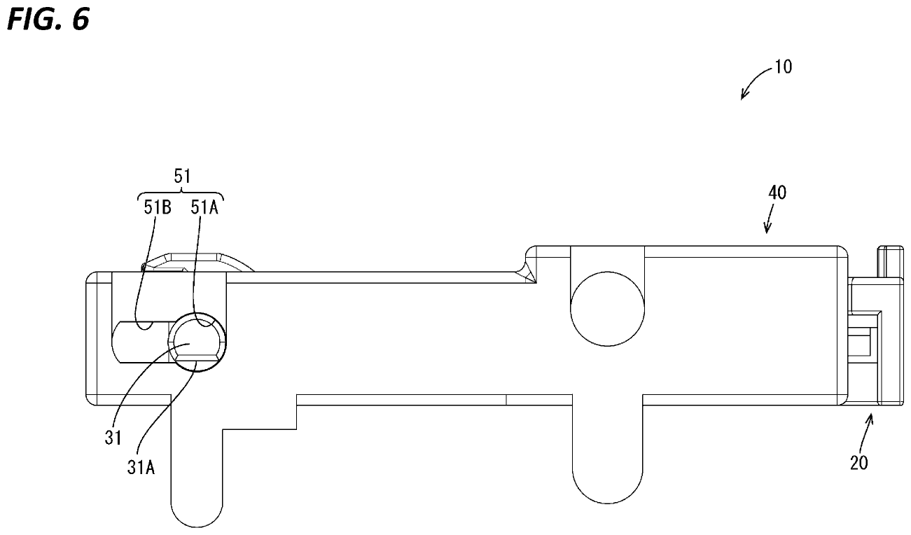

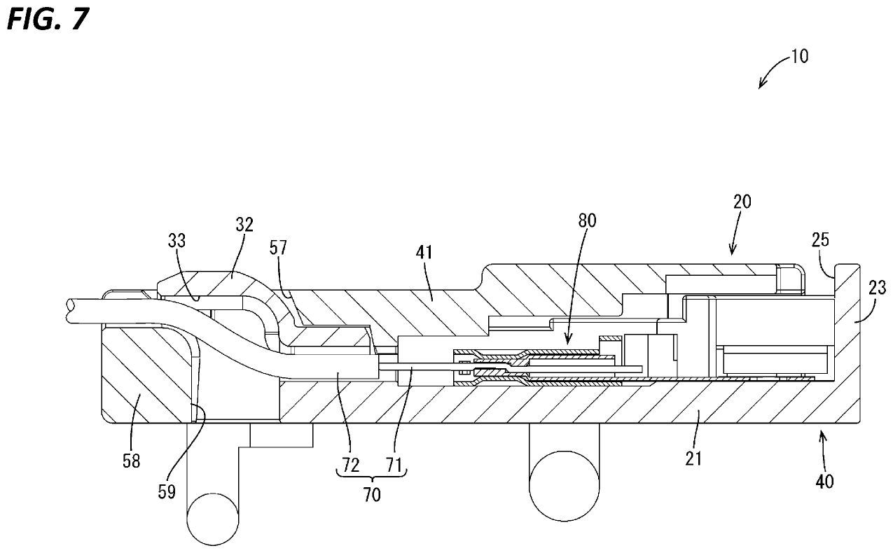

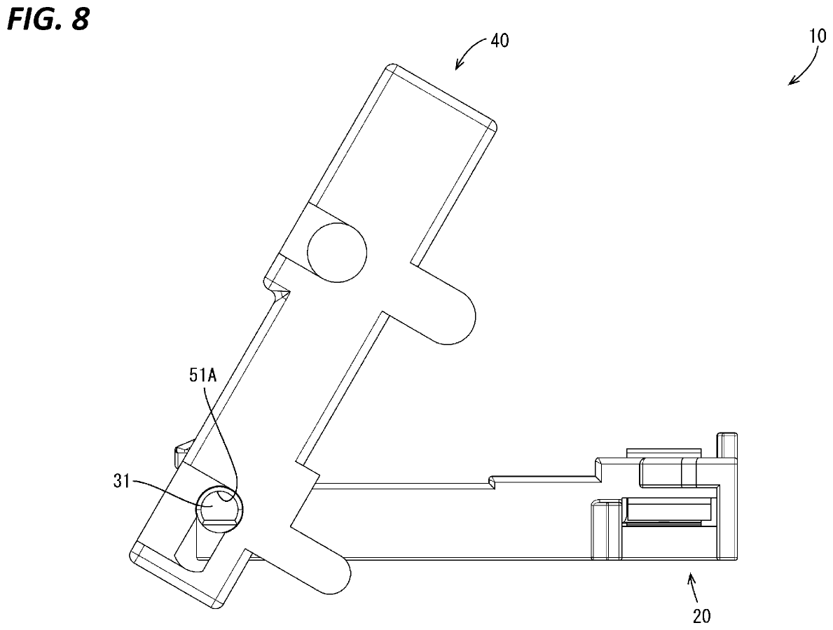

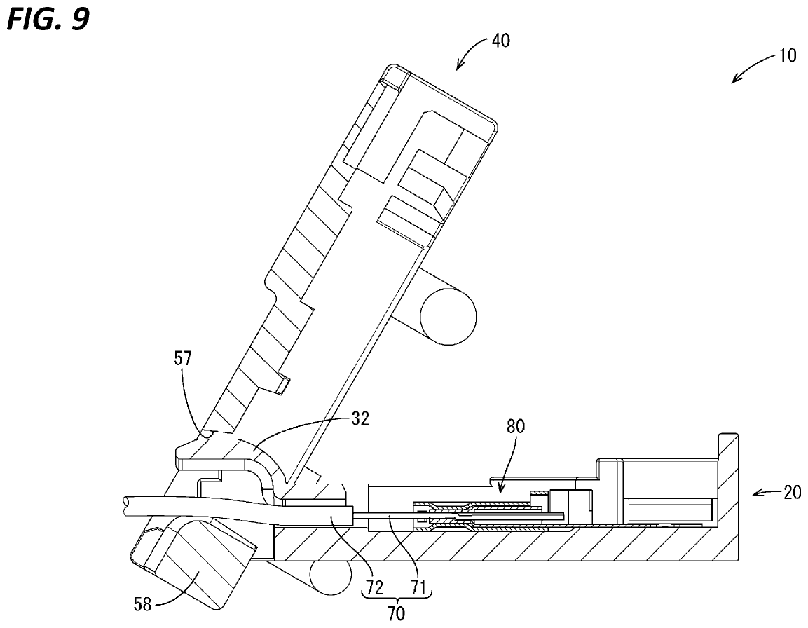

The sub-connector 10 of this embodiment is a joint connector provided with a joint terminal 80 (an example of a terminal). This sub-connector 10 is provided with the joint terminal 80, a plurality of wires 70 to be connected to the joint terminal 80, a lower housing 20 including an opening 25 and configured to accommodate the joint terminal 80, and an upper cover 40 to be assembled with the lower housing 20 to close the opening 25 as shown in FIGS. 2 and 4. The upper cover 40 is slidable between a complete closing position (position shown in FIGS. 2 to 5) for closing the entire opening 25 and a temporary closing position (position shown in FIGS. 6 and 7) shifted from the complete closing position, and rotatable between the temporary closing position and an opening position (position shown in FIGS. 8 and 9) for opening the opening 25. In the following description, suffixes A, B are added to the reference signs of the sub-connectors 10 when the respective sub-connectors 10 are distinguished, whereas no suffix is added to the reference signs when the respective sub-connectors 10 are collectively called.

### Lower Housing 20

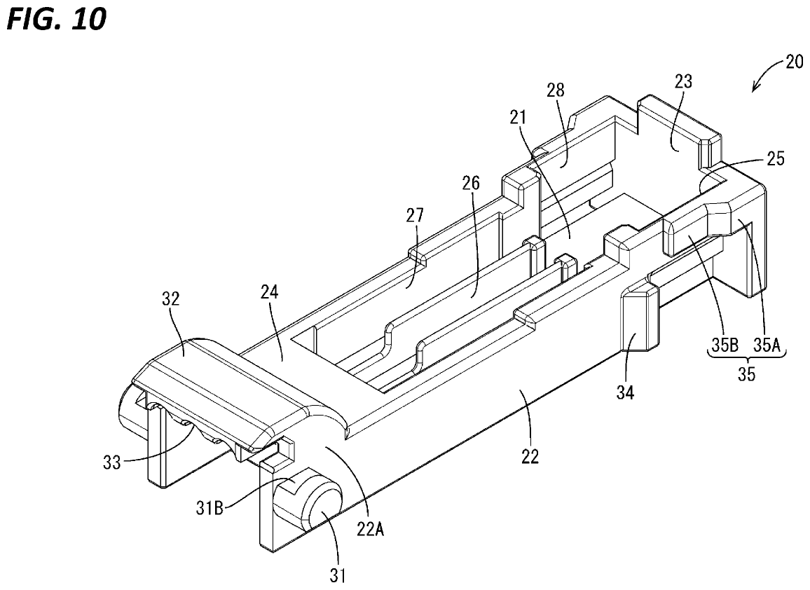

The lower housing 20 is made of synthetic resin and, as shown in FIG. 10, in the form of a rectangular box having an opening 25. This lower housing 20 includes an elongated rectangular bottom wall 21, a pair of inner side walls 21 rising perpendicularly from a pair of long sides of the bottom wall 21, a front wall 23 rising perpendicularly from one short side of the bottom wall 21 and linking the pair of inner side walls 22 and an inner rear wall 24 rising perpendicularly from the other short side of the bottom wall 21 and linking the pair of inner side walls 22. A plurality of separation walls 26 rising from the bottom wall 21 are disposed inside the lower housing 20. The plurality of separation walls 26 are disposed in parallel to the pair of inner side walls 22. A space between the adjacent separation walls 26 and spaces between the separation walls 22 and the inner side walls 22 respectively serve as cavities 27, and a space between the separation walls 26 and the front wall 23 serves as a coupling portion accommodating portion 28. As shown in FIG. 4, the inner rear wall 24 includes a plurality of first wire insertion holes 29 respectively communicating with a plurality of the cavities 27. A part of each inner side wall 22 serves as an extended portion 22A extended from the inner rear wall 24 toward a side opposite to the front wall 23 and a side opposite to the bottom wall 21.

The lower housing 20 further includes a pair of shaft portions 31 used to assemble the upper cover 40, a lower guide portion 32 for guiding the wires 70, a pair of closing projections 34 for holding the upper cover 40 at the complete closing position or temporary closing position and a pair of slide guides 35 for guiding a sliding movement of the upper cover 40.

As shown in FIG. 10, each shaft portion 31 has a cylindrical shape as a whole and projects outward from the extended portion 22A. The outer peripheral surface of the shaft portion 31 has a first flat surface 31A and a second flat surface 31B parallel to each other. The first flat surface 31A is a flat surface parallel to the bottom wall 21, out of cut surfaces formed by cutting a part of the shaft portion 31 adjacent to a projecting end as shown in FIG. 6. The second flat surface 31B is a flat surface parallel to the bottom wall 21, out of cut surfaces formed by cutting a part of the shaft portion 31 adjacent to the inner side wall 22 as shown in FIG. 10. The first flat surface 31A is disposed on the side of the bottom wall 21 on the outer peripheral surface of the shaft portion 31, and the second flat surface 31B is disposed on an opposite side.

The lower guide portion 32 is a wall linking a pair of the extended portions 22A as shown in FIG. 10 and includes an arcuate wall portion 32A extending in an arched manner from the inner rear wall 24 and a flat plate portion 32B in the form of a flat plate extending from the arcuate wall portion 32A and parallel to the bottom wall 21 as shown in FIG. 4. This lower housing 20 includes a plurality of first wire insertion grooves 33 as shown in FIGS. 4 and 10. Each first wire insertion groove 33 is a groove arranged in the inner surface of the lower guide portion 32 and defined by a halfpipe-like groove wall and extends from a connected part to the inner rear wall 24 to an extending end of the flat plate portion 32B, and one end thereof is connected to the corresponding wire insertion hole 29.

As shown in FIG. 10, each slide guide 35 is an elongated ridge projecting outward from each inner side wall 22, disposed adjacent to the front wall 23 and extends along an opening edge of the opening 25. A half of the slide guide 35 adjacent to the front wall 23 serves as a thick portion 35A having a relatively large projection amount from the inner side wall 22, and the remaining half serves as a thin portion 35B having a smaller projection amount from the inner side wall 22 than the thick portion 35B.

Each closing projection 34 is a projection projecting outward from each inner side wall 22 as shown in FIG. 10.

### Upper Cover 40

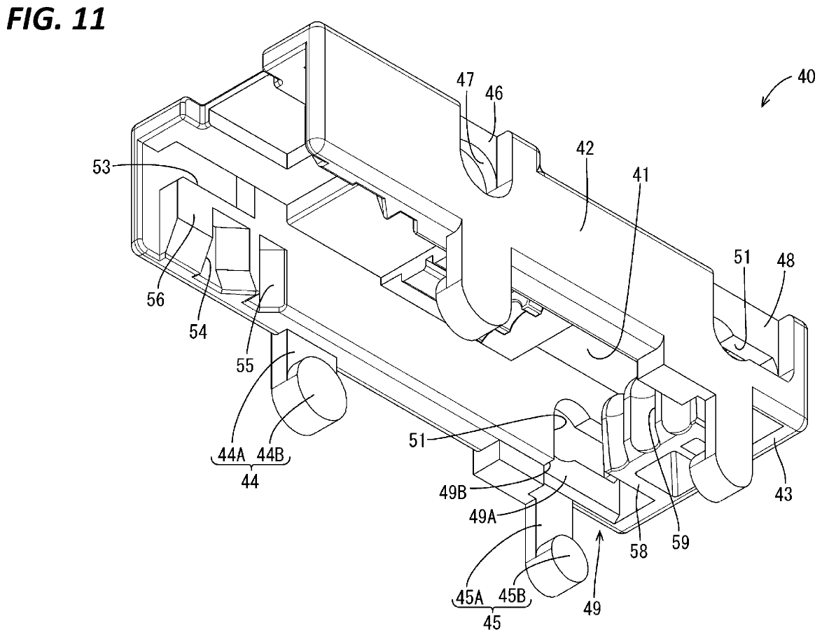

The upper cover 40 is made of synthetic resin and, as shown in FIG. 11, has an elongated rectangular shape and includes a ceiling wall 41 for closing the opening 25 of the lower housing 20, a pair of outer side walls 42 extending perpendicularly from a pair of long sides of the bottom wall 21 and to be disposed outside the inner side walls 22, an outer rear wall 43 extending perpendicularly from one short side of the ceiling wall 41 and linking the pair of outer side walls 42, a pair of fixing portions 44 respectively extending from the pair of outer side walls 42, and a pair of movement restricting portions 45 likewise respectively extending from the pair of outer side walls 42. The fixing portions 44 and the movement restricting portions 45 hold one sub-connector 10 inseparably from another sub-connector 10.

Two fixing portions 44 are arranged to face each other as shown in FIG. 11. Each fixing portion 44 includes a fixing piece 44A extending from the outer side wall 42 and a cylindrical fixing protrusion 44B projecting inward from this fixing piece 44A. The fixing piece 44A is in the form of a plate piece having a smaller thickness than the outer side wall 42. The outer surface of the fixing piece 44A is flush with that of the outer side wall 42.

Two movement restricting portions 45 are arranged to face each other as shown in FIG. 11. Each movement restricting portion 45 includes a restricting piece 45A extending from the outer side wall 42 and a restricting protrusion 45B projecting inward from this restricting piece 45A. The restricting piece 45A is in the form of a plate piece having a smaller thickness than the outer side wall 42 and has a length and a width different from those of the fixing piece 44A. The outer surface of the restricting piece 45A is flush with that of the outer side wall 42. The restricting protrusion 45B has a cylindrical shape one size smaller than the fixing protrusion 44B.

As shown in FIG. 11, each outer side wall 42 is provided with a fixing groove 46, a fixing recess 47, a restricting groove 48, an entrance groove 49 and a shaft hole 51.

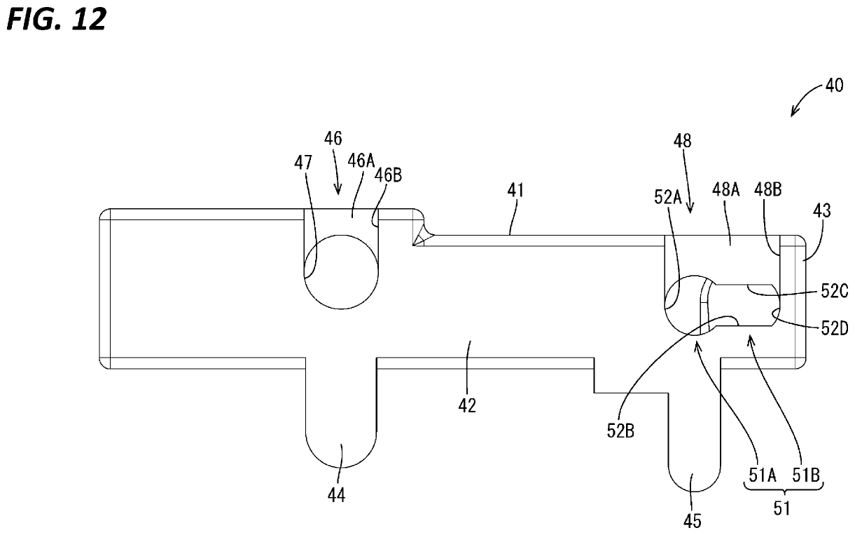

As shown in FIG. 12, the fixing groove 46 is a groove arranged in the outer surface of the outer side wall 42 and defined by a first groove bottom surface 46A parallel to the outer surface of the outer side wall 42 and a first groove side surface 46B linking the first groove bottom surface 46A and the outer surface of the outer side wall 42. This fixing groove 46 is open on the side of the ceiling wall 41, extends toward an extending end of the outer side wall 42 and can receive the fixing piece 44A of another sub-connector 10. The fixing groove 46 has such width, vertical depth and horizontal depth that the fixing piece 44A is just fit therein. The fixing recess 47 is a recess disposed in a back end part of the fixing groove 46 and recessed from the first groove bottom surface 46A, and can receive the fixing protrusion 44B of the other sub-connector 10.

As shown in FIG. 12, the restricting groove 48 is arranged in the outer surface of the outer side wall 42, has a second groove bottom surface 48A parallel to the outer surface of the outer side wall 42 and a second groove side surface 48B linking the second groove bottom surface 48A and the outer surface of the outer side wall 42 and can receive the restricting piece 45A of the other sub-connector 10. This restricting groove 48 has a width larger than that of the restricting piece 45A and has such vertical depth and horizontal depth that the restricting piece 45A is just fit therein.

As shown in FIG. 11, the entrance groove 49 is a groove arranged in the inner surface of the outer side wall 42 and defined by a third groove bottom surface 49A parallel to the inner surface of the outer side wall 42 and a third groove side surface 49B linking the third groove bottom surface 49A and the inner surface of the outer side wall 42. This entrance groove 49 is open on the extending end of the outer side wall 42 and extends toward the ceiling wall 41 and allows the entrance of the shaft portion 31 when the upper cover 40 is assembled with the lower housing 20. The entrance groove 49 has a width equivalent to that of the restricting groove 48 and a back end part of the entrance groove 49 is located just on the underside of the back end part of the restricting groove 48.

As shown in FIGS. 11 and 12, the shaft hole 51 is a hole disposed in the back end parts of the restricting groove 48 and the entrance groove 49 and penetrating through the outer side wall 42. More specifically, the shaft hole 51 penetrates between the second groove bottom surface 48A and the third groove bottom surface 49A. As shown in FIG. 12, the shaft hole 51 is an elongated hole extending in a direction parallel to the ceiling wall 41, a part of the shaft hole 51 on the side of the outer rear wall 43 serves as a rotation restricting portion 51B and the remaining part serves as a rotation allowing portion 51A.

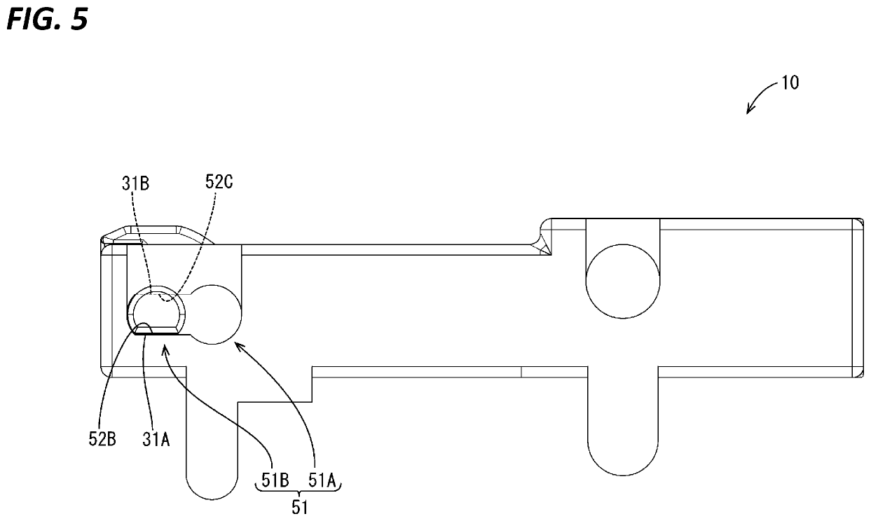

The rotation allowing portion 51A is a hole part defined by a C-shaped arcuate first inner peripheral surface 52A along the outer peripheral surface of the shaft portion 31. When the upper cover 40 is at the opening position and the temporary closing position, the shaft portion 31 is rotatably accommodated in the rotation allowing portion 51A as shown in FIGS. 6 and 8. As shown in FIG. 12, the rotation restricting portion 51B is a hole part defined by a second inner peripheral surface 52B extending from one end of the first inner peripheral surface 52A and parallel to the ceiling wall 41, a third inner peripheral surface 52C extending from the other end of the first inner peripheral surface 52A and parallel to the ceiling wall 41 and an arched fourth inner peripheral surface 52D linking the second and third inner peripheral surfaces 52B, 52C. With the upper cover 40 located at the complete closing position, the shaft portion 31 is accommodated in the rotation restricting portion 51B, the first flat surface 31A is disposed along the second inner peripheral surface 52B and the second flat surface 31B is disposed along the third inner peripheral surface 52C as shown in FIG. 5. If the shaft portion 31 is going to rotate, the second and third inner peripheral surfaces 52B, 52C respectively interfere with the first and second flat surfaces 31A, 31B, thereby restricting any further rotation of the shaft portion 31.

Each outer side wall 42 further includes a slide groove 53 for receiving the slide guide 35 and a temporary closing recess 54 and a complete closing recess 55 for receiving the closing projection 34. As shown in FIG. 11, the slide groove 53 is a groove arranged in the inner surface of the outer side wall 42, open on a side opposite to the outer rear wall 43 and extends along the ceiling wall 41. As shown in FIG. 11, a part between the slide guide 35 and the extending end of the outer side wall 42 serves as an upper lock portion 56, and the temporary closing recess 54 recessed from the inner surface of the outer side wall 42 and configured to receive the closing projection 34 when the upper cover 40 is at the temporary closing position is disposed in this upper lock portion 56. Further, the complete closing recess 55 for receiving the closing projection 34 when the upper cover 40 is at the complete closing position is disposed at a position closer to the outer rear wall 43 than the complete closing recess 55 in the outer side wall 42.

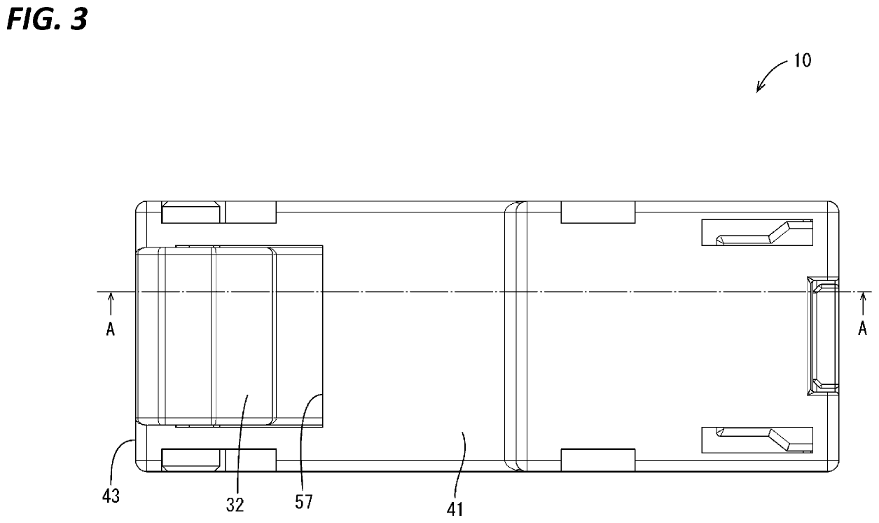

The ceiling wall 41 includes a wire lead-out opening 57. The lead-out opening 57 is a through hole for leading out the wires 70 to the outside of the sub-connector 10, and arranged adjacent to the rear outer wall 43 as shown in FIGS. 2 and 3. This lead-out opening 57 can receive the lower guide portion 32 inside.

The upper cover 40 further includes an upper guide portion 58. The upper guide portion 58 is in the form of a block and projects inward from the outer rear wall 43 as shown in FIGS. 4 and 11. This upper guide portion 58 has an outer surface facing the inner surface of the lower guide portion 32 and facing the inner surface of the arcuate wall portion 32A and the inner rear wall 24 when the upper cover 40 is at the complete closing position, and a plurality of second wire insertion grooves 59 are disposed in this outer surface. Each second wire insertion groove 59 is a groove defined by a halfpipe-like groove wall. Each second wire insertion groove 59 is connected to the corresponding first wire insertion groove 33.

### Wires 70

As shown in FIG. 4, each wire 70 includes an electrically conductive core wire 71 and an insulating insulation coating 72 for covering the core wire 71. At an end part of the wire 70, the insulation coating 72 is stripped to expose the core wire 71. The core wire 71 may be one metal wire or a stranded wire formed by stranding a plurality of thin metal wires. An arbitrary metal such as copper, copper alloy, aluminum or aluminum alloy can be appropriately selected as a metal constituting the core wire 71 if necessary. The insulation coating 72 is made of synthetic resin. Note that the wires 70 are not shown in figures except FIGS. 4, 7, 9, 15 and 18 in view of easy viewing of the figures.

### Joint Terminal 80

The joint terminal 80 is formed into a predetermined shape by a known method such as press-working, cutting or forging. An arbitrary metal such as copper, copper alloy, aluminum, aluminum alloy or stainless steel can be appropriately selected as a metal constituting the joint terminal 80 if necessary. The joint terminal 80 according to this embodiment is made of copper or copper alloy. A plating layer may be formed on the surface of the joint terminal 80. An arbitrary metal such as tin, nickel or silver can be appropriately selected as a metal constituting the plating layer if necessary. Tin plating is applied to the joint terminal 80 according to this embodiment.

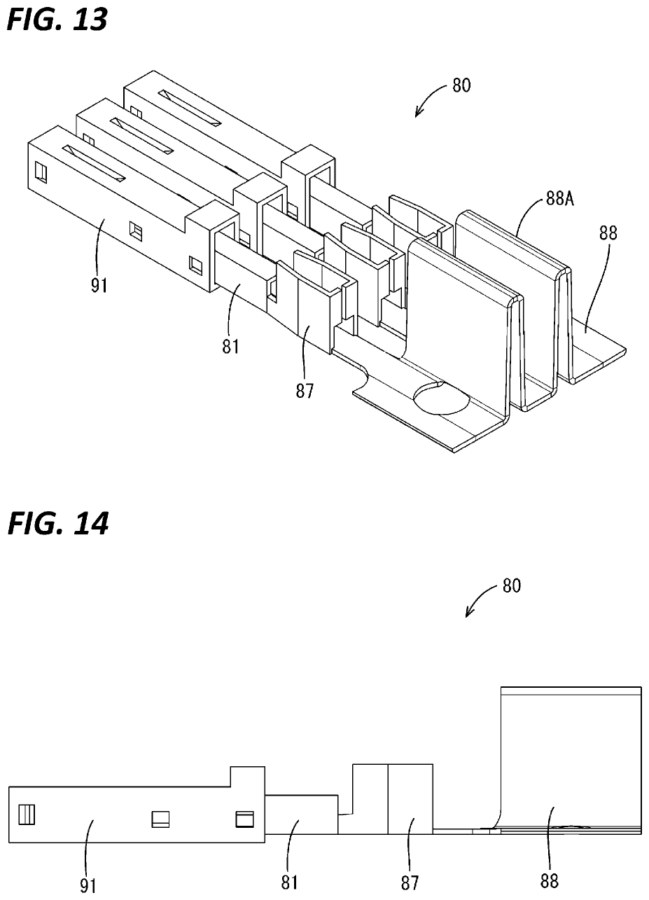

As shown in FIGS. 13 and 14, this joint terminal 80 includes a plurality of terminal bodies 81, a plurality of intermediate portions 87 respectively extending from the plurality of terminal bodies 81, a coupling portion 88 linking the plurality of terminal bodies 81 via the intermediate portions 87, and a plurality of slide members 91 to be respectively assembled with the plurality of terminal bodies 81.

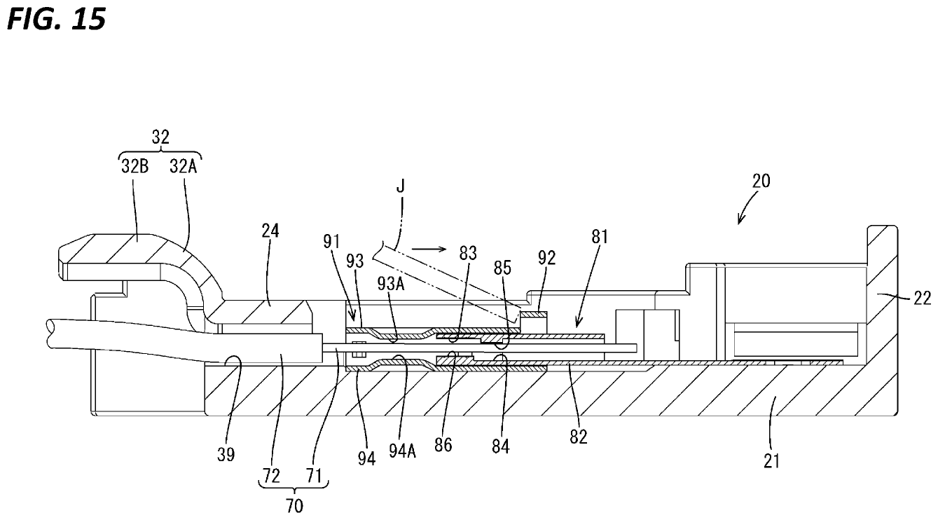

As shown in FIG. 15, each terminal body 81 includes a tube portion 82 in the form of a rectangular tube and plate-like upper sandwiching portion 83 and lower sandwiching portion 84 extending from the tube portion 82. The upper and lower sandwiching portions 83, 84 are disposed to extend from one end (left end of FIG. 15) of the tube portion 82 and face each other. An upper sandwiching projection 85 projects toward the lower sandwiching portion 84 from the upper sandwiching portion 83. A lower sandwiching projection 86 projects toward the upper sandwiching portion 83 from the lower sandwiching portion 84. The upper and lower sandwiching projections 85, 86 are provided at positions shifted from each other.

As shown in FIGS. 13 and 14, the intermediate portion 87 extends from one end of each terminal body 81, and an extending end of this intermediate portion 87 is connected to the coupling portion 88. As shown in FIG. 13, the coupling portion 88 is plate-like and includes a plurality of bent portions 88A bent into a chevron shape.

As shown in FIGS. 13, 14 and 15, each slide member 91 is in the form of a rectangular tube one size larger than the terminal body 81 and disposed to surround the terminal body 81. This slide member 91 is slidable between a partial locking position (position of FIG. 15) for covering only a part of the terminal body 81 and a full locking position (position of FIG. 4) for covering the entire terminal body 81. A jig receiving portion 92 for receiving a jig J for sliding the slide member 91 with respect to the terminal body 81 is provided to project on one end of the slide member 91.

As shown in FIG. 15, the slide member 91 has an upper wall 93 and a lower wall 94 disposed to face each other. A part of the upper wall 93 serves as an upper pressurizing portion 93A bulging toward the lower wall 94. A part of the lower wall 94 serves as a lower pressurizing portion 94A bulging toward the upper wall 93. When the slide member 91 is at the full locking position, the upper pressurizing portion 93A presses the upper sandwiching portion 83 and the lower pressurizing portion 94 presses the lower sandwiching portion 84, whereby the upper and lower sandwiching portions 83, 84 are deformed to approach each other and sandwich the core wire 71 between the upper and lower sandwiching projections 85, 86.

### Lock Member 100

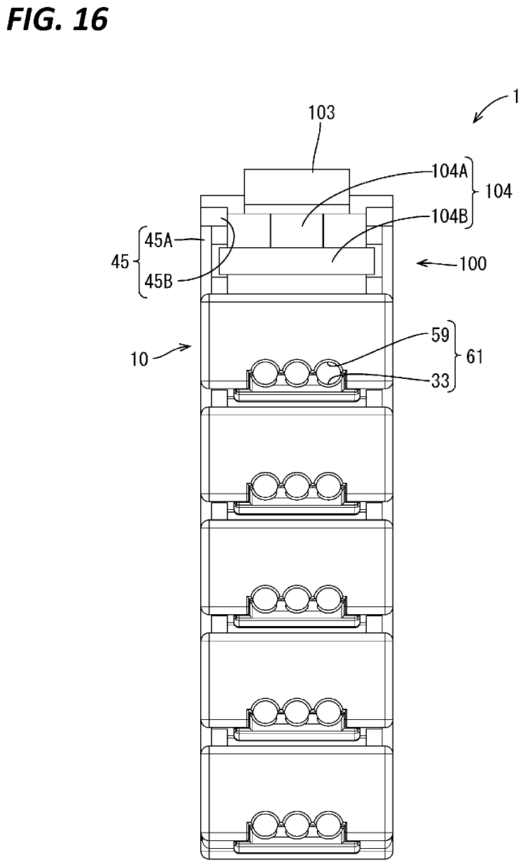

As shown in FIGS. 1 and 16, the lock member 100 includes a main wall 101, a pair of leg portions 102 extending from the main wall 101, a lock arm 103 likewise extending from the main wall 101 and a deflection restricting portion 104 connected to the lock arm 103.

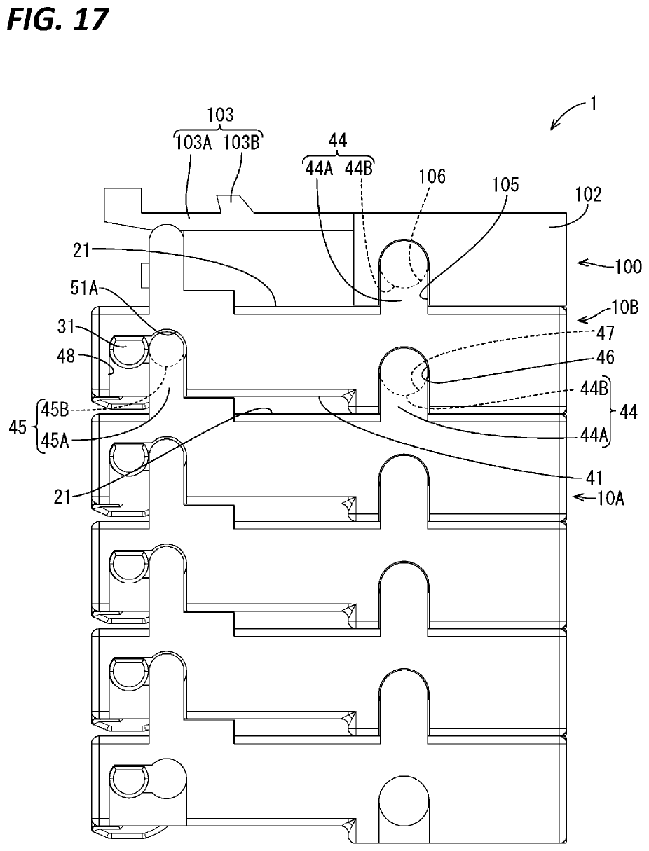

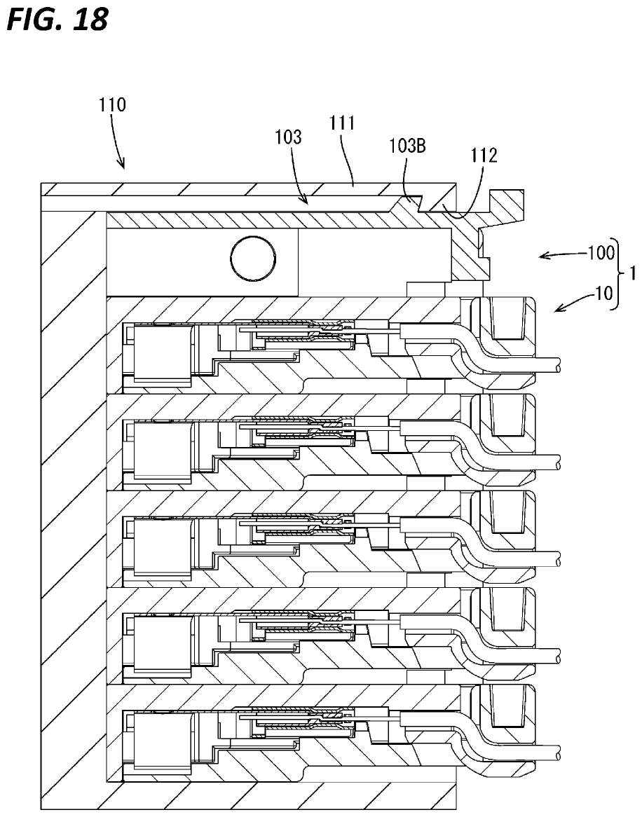

The main wall 101 has a rectangular shape having a length which is about half the length of the bottom wall 21. The pair of leg portions 102 extend perpendicularly from a pair of long sides of the bottom wall 21. Two leg portions 102 are disposed to face each other. As shown in FIG. 17, each leg portion 102 includes a fixing groove 105 and a fixing recess 106 and is engageable with the fixing portion 44 of the sub-connector 10. The fixing groove 105 and the fixing recess 106 are shaped similarly to the fixing groove 46 and the fixing recess 47 of the upper cover 40. The fixing groove 105 is open in an extending end of the leg portion 102 and extends toward the main wall 101.

The lock arm 103 includes a leaf spring-like arm body 103 extending from the bottom wall 21 and a lock projection 103B (an example of a lock portion) projecting from the arm body 103. With the lock member 100 assembled with the sub-connector 10, the lock arm 103 is deflectable in a direction toward the sub-connector 10 and the lock projection 103B projects toward a side opposite to the sub-connector 10.

The deflection restricting portion 104 includes a coupling column 104A and an interfering portion 104B. The interfering portion 104B is in the form of an elongated plate and extends in a direction intersecting an extending direction of the lock arm 103. The coupling column 104A connects the lock arm 103 and the interfering portion 104B.

### Assembling Process of Sub-Connector 10

Next, an example of a process of assembling the sub-connector 10 configured as described above is described.

First, the joint terminal 80 is assembled. The slide members 91 are assembled with the terminal bodies 81 and held at the partial locking position (see FIG. 14). In this way, the assembling of the joint terminal 80 is completed.

Subsequently, the joint terminal 80 is accommodated into the lower housing 20. One set of the terminal body 81, the slide member 91 assembled with the terminal body 81 and the intermediate portion 87 connected to the terminal body 81 is accommodated inside one cavity 27. The coupling portion 88 is accommodated in the coupling portion accommodating portion 28.

Subsequently, the wires 70 are connected to the joint terminal 80. The end part of each wire 70 is inserted into the lower housing 20 through the corresponding wire insertion hole 29 (see FIG. 15). The wire 70 enters the cavity 27 and the core wire 71 enters the slide member 91 and reaches a space between the upper and lower sandwiching portions 83, 84. Subsequently, the jig receiving portion 92 is pushed by the jig J, whereby the slide member 91 is slid from the partial locking position to the full locking position. If the slide member 91 is held at the full locking position, the upper pressurizing portion 93A presses the upper sandwiching portion 83 and the lower pressurizing portion 94A presses the lower sandwiching portion 84. In this way, the upper and lower sandwiching portions 83, 84 are deformed to approach each other and the core wire 71 is sandwiched between the upper and lower sandwiching projections 85, 86 while being bent (see FIG. 9). In this way, the mounting of the wire 70 into the joint terminal 80 is completed.

Subsequently, the upper cover 40 is assembled with the lower housing 20 (see FIGS. 8 and 9). First, the wires 70 led out from the lower housing 20 are passed through the wire lead-out opening 57. Subsequently, the shaft portions 31 are fit into the shaft holes 51. In this stage, the upper cover 40 is at the opening position to be at an angle to the lower housing 20 as shown in FIGS. 8 and 9. The shaft portions 31 are rotatably accommodated into the rotation allowing portions 51A to allow the rotation of the upper cover 40 with respect to the lower housing 20.

Subsequently, the upper cover 40 is rotated from the opening position to the temporary closing position with the shaft portions 31 as an axis of rotation (see FIGS. 6 and 7). When the upper cover 40 reaches the temporary closing position, the thin portions 35B of the slide guides 35 ride over the upper lock portions 56 and enter the slide grooves 53. Further, the closing projections 34 are accommodated into the temporary closing recesses 54. In this way, the upper cover 40 is held at the temporary closing position. With the upper cover 40 located at the temporary closing position, a part of the lower housing 20 on the side of the front wall 23 protrudes out from the upper cover 40. The opening 25 of the lower housing 20 is mostly closed by the upper cover 40, except a part on the side of the front wall 23.

Subsequently, the upper cover 40 is slid from the temporary closing position to the complete closing position (see FIGS. 4 and 5). The thick portions 35A of the slide guides 35 enter the slide grooves 53, whereby a sliding movement of the upper cover 40 is guided. Further, the shaft portions 31 move from the rotation allowing portions 51A to the rotation restricting portions 51B. When the upper cover 40 reaches the complete closing position, the closing projections 34 are accommodated in the complete closing recesses 55. In this way, the upper cover 40 is held at the complete closing position.

With the upper cover 40 located at the complete closing position, the entire lower housing 20 is accommodated inside the upper cover 40 and the entire opening 25 of the lower housing 20 is closed by the upper cover 40 as shown in FIG. 5. In this way, the entire joint terminal 80 is covered by the upper cover 40. As shown in FIG. 4, the lower guide portion 32 and the upper guide portion 58 are disposed to face each other, and the respective first wire insertion grooves 33 and the corresponding second wire insertion grooves 59 are joined to form second wire insertion holes 61. A plurality of the second wire insertion holes 61 respectively communicate with the plurality of first wire insertion holes 29. Each wire 70 is inserted into each second wire insertion hole 61, thereby being held in a bent state corresponding to the arched shape of the lower guide portion 32. As shown in FIG. 5, the shaft portion 31 is held in the rotation restricting portion 51B and the rotation thereof is restricted by the contact of the first flat surface 31A with the second inner peripheral surface 52B and the contact of the second flat surface 31B with the third inner peripheral surface 52C. In this way, the rotation of the upper cover 40 is restricted. The fixing portions 44 and the movement restricting portions 45 provided in the upper cover 40 project perpendicular to the bottom wall 21 of the lower housing 20.

### Assembling Process of Connector Unit 1

Next, an example of an assembling process of the connector unit 1 is described in which the plurality of sub-connectors 10 and the lock member 100 configured as described above are assembled.

First, one sub-connector 10A is assembled with another sub-connector 10B (see FIGS. 1 and 17). The two sub-connectors 10A, 10B are so stacked that the bottom wall 21 of the sub-connector 10A and the ceiling wall 41 of the sub-connector 10B face each other. If the sub-connector 10A is pressed toward the sub-connector 10B, the fixing portions 44 of the sub-connector 10A enter the fixing grooves 46 of the sub-connector 10B. The fixing protrusions 44B ride on the first groove bottom surfaces 46A, whereby the two fixing portions 44 are expanded and deformed. Further, the movement restricting portions 45 of the sub-connector 10A enter the restricting grooves 48 of the sub-connector 10B. The restricting protrusions 45B ride on the second groove bottom surfaces 48A, whereby the two movement restricting portions 45 are expanded and deformed. If the sub-connector 10B reaches a proper assembly position with respect to the sub-connector 10A, the fixing protrusions 44B are fit into the fixing recesses 47 and the fixing pieces 44A resiliently return to be accommodated into the fixing grooves 46. Further, the restricting protrusions 45B are fit into the rotation allowing portions 51A of the shaft holes 51 and the restricting pieces 45A resiliently return to be accommodated into the restricting grooves 48. In this way, the two sub-connectors 10A, 10B are held inseparably from each other.

With the two sub-connectors 10A, 10B assembled, the restricting protrusions 45B of the sub-connector 10A are fit in the rotation allowing portions 51A of the sub-connector 10B, whereby the shaft portions 31 of the sub-connector 10B are restricted from moving from the rotation restricting portions 51B to the rotation allowing portions 51A. Thus, the upper cover 40 of the sub-connector 10B is also restricted from moving from the complete closing position to the temporary closing position. In this way, the upper cover 40 of the sub-connector 10B is also restricted from rotating to the opening position.

Similarly, the remaining sub-connectors 10 are successively assembled and a stacked body of five sub-connectors 10 is obtained. The fixing portions 44 and the movement restricting portions 45 provided in the sub-connector 10B located on the very end are in a free state without being engaged with another sub-connector 10.

Subsequently, the lock member 100 is assembled with the sub-connector 10B located on the very end (upper end of FIGS. 1 and 17). The lock member 100 is so assembled with the sub-connector 10B that the main wall 101 is located on the side of the front wall 23 and the lock arm 103 is located on the side of the inner rear wall 24. If the lock member 100 is pressed toward the sub-connector 10B, the fixing portions 44 of the sub-connector 10B enter the fixing grooves 105 of the lock member 100 and the two fixing portions 44 are expanded and deformed. If the lock member 100 reaches a proper assembly position with respect to the sub-connector 10B, the fixing protrusions 44B are fit into the fixing recesses 106 and the fixing pieces 44A resiliently return to be accommodated into the fixing grooves 105. In this way, the lock member 100 is held inseparably from the sub-connector 10B. In the above way, the assembling of the connector unit 1 is completed.

With the lock member 100 assembled with the sub-connector 10B, the main wall 101 and the lock arm 103 are disposed in parallel to and at a distance from the bottom wall 21 of the sub-connector 10B as shown in FIG. 17. The arm body 103A has such a width as to be passable between the two restricting protrusions 45B, and the lock arm 103 is allowed to be deflected in a direction toward the sub-connector 10B (downward direction of FIG. 16, releasing direction). The interfering portion 104B has such a length as to be unpassable between the two restricting protrusions 45B as shown in FIG. 16. One end of the interfering portion 104B is inserted between one restricting protrusion 45B of the sub-connector 10B and the bottom wall 21 and the other end of the interfering portion 104 is inserted between the other restricting protrusion 45B and the bottom wall 21. If the lock arm 103 is deflected in a direction away from the sub-connector 10B (upward direction of FIG. 16, direction opposite to the releasing direction), the interfering portion 104B interferes with the restricting protrusions 45B to restrict any further deflection of the lock arm 103.

### Connection of Connector Unit 1 and Mating Member 110

The mating member 110 to be connected to the connector unit 1 includes a receptacle 111 capable of accommodating the connector unit 1 inside as shown in FIG. 18. This receptacle 111 includes a lock receiving portion 112 projecting inward to be engaged with the lock projection 103B. In connecting the connector unit 1 to the mating member 110, the connector unit 1 is inserted into the receptacle 111 with the front walls 23 in the lead. Then, the lock projection 103 rides on the lock receiving portion 112 and the lock arm 103 is deflected and deformed in the direction approaching the sub-connectors 10 (releasing direction). If the connector unit 1 reaches a proper connection position, the lock projection 103B rides over the lock receiving portion 112, the lock arm 103 resiliently returns and the lock projection 103B is engaged with the lock receiving portion 112, whereby the connector unit 1 is held inseparably from the receptacle 111BV

### Maintenance of Connector Unit 1

At the time of maintenance of the connector unit 1, the lock arm 103 is further pressed in the releasing direction and the lock projection 103B and the lock receiving portion 112 are disengaged. In this state, the connector unit 1 is removed from the mating member 110. Subsequently, the fixing portions 44 and the movement restricting portions 45 of the sub-connector 10B are respectively expanded and deformed, and the lock member 100 is separated from the sub-connector 10B. Subsequently, the fixing portions 44 and the movement restricting portions 45 of the sub-connector 10A are respectively expanded and deformed and the sub-connector 10B is separated from the sub-connector 10A. Similarly, the other sub-connectors 10 are successively separated. In each sub-connector 10 after separation, the shaft portions 31 are allowed to move from the rotation restricting portions 51B to the rotation allowing portions 51A.

Subsequently, the upper cover 40 is moved from the complete closing position to the temporary closing position for each sub-connector 10. In this way, the shaft portions 31 move to the rotation allowing portions 51A and the rotation of the upper cover 40 is allowed. Subsequently, the upper cover 40 is rotated from the temporary closing position to the opening position. In this way, the opening 25 of the lower housing 20 is opened and the joint terminal 80 can be taken out from the lower housing 20.

### Functions and Effects

As described above, according to this embodiment, the connector unit 1 is provided with the plurality of coupled sub-connectors 10. The sub-connector 10 includes the joint terminal 80, the lower housing 20 having the opening 25 and configured to accommodate the joint terminal 80, and the upper cover 40 to be assembled with the lower housing 20 to close the opening 25. The upper cover 40 is slidable between the complete closing position for closing the entire opening 25 and the temporary closing position shifted from the complete closing position and rotatable between the temporary closing position and the opening position for opening the opening 25. One of the lower housing 20 and the upper cover 40 includes the rotation allowing portions 51A for allowing the rotation of the upper cover 40 to the opening position when the upper cover 40 is at the temporary closing position and the rotation restricting portions 51B for restricting the rotation of the upper cover 40 to the opening position when the upper cover 40 is at the complete closing position. One sub-connector 10A, out of the plurality of sub-connectors 10, includes the movement restricting portions 45 for holding the one sub-connector 10A inseparably from the other sub-connector 10B by being engaged with the other sub-connector 10B and restricting a sliding movement of the upper cover 40 provided in the other sub-connector 10B from the complete closing position to the temporary closing position.

According to the above configuration, the sliding movement of the upper cover 40 of the other sub-connector 10B from the complete closing position to the temporary closing position is restricted by the movement restricting portions 45 of the one sub-connector 10A. Since the rotation to the opening position is restricted with the upper cover 40 located at the complete closing position, it is avoided during the assembling operation of the connector unit 1 with another member or during use that the upper cover 40 is opened to pose a problem for the assembling operation or use. Further, since the movement restricting portions 45 have both a function of holding the one sub-connector 10A on the other sub-connector 10B and a function of restricting a movement of the upper cover 40, a configuration is simplified.

Further, the lower housing 20 includes the shaft portions 31, the upper cover 40 includes the shaft holes 51 for receiving the shaft portions 31, parts of the shaft holes 51 serve as the rotation allowing portions 51A for rotatably accommodating the shaft portions 31 when the upper cover 40 is at the temporary closing position, the other parts of the shaft holes 51 serve as the rotation restricting portions 51B for accommodating the shaft portions 31 while restricting the rotation when the upper cover 40 is at the complete closing position, and the restricting protrusions 45B of the movement restricting portions 45 of the one sub-connector 10A are accommodated in the rotation allowing portions 51A of the other sub-connector 10B.

According to this configuration, since the shaft holes 51 can be used as the rotation allowing portions 51A and the rotation restricting portions 51B, a configuration for restricting the rotation of the upper cover 40 needs not be separately provided and the configuration is simplified.

In addition, the connector unit 1 is further provided with the lock member 100 to be assembled with the other sub-connector 10B. The lock member 100 includes the lock arm 103 having the lock projection 103 to be engaged with the mating member 110 and deflectable in the releasing direction for releasing the engagement of the lock projection 103B with the mating member 110, and the deflection restricting portion 104 connected to the lock arm 103 and configured to restrict the deflection of the lock arm 103 in the direction opposite to the releasing direction by being engaged with the movement restricting portions 45 provided in the other sub-connector 10B.

According to the above configuration, since the movement restricting portions 45 can be also used to restrict the deflection of the lock arm 103, the sub-connector 10 needs not be separately provided with a configuration for restricting the deflection of the lock arm 103 and the configuration is simplified.

### Modification

A connector unit 120 of a modification differs from the above embodiment in that a sub-connector 130 includes a plurality of female terminals 135 (an example of a terminal) instead of the joint terminal 80.

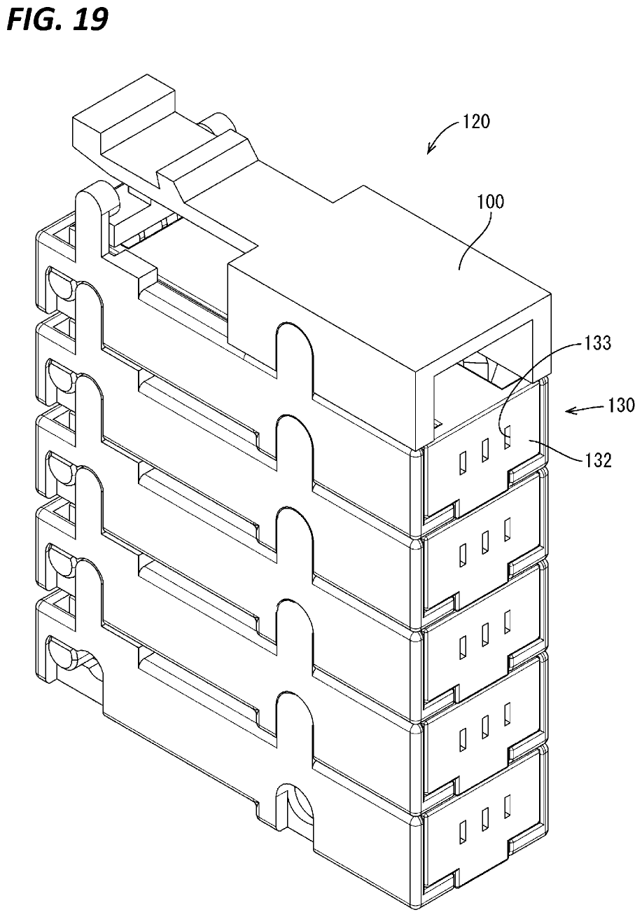

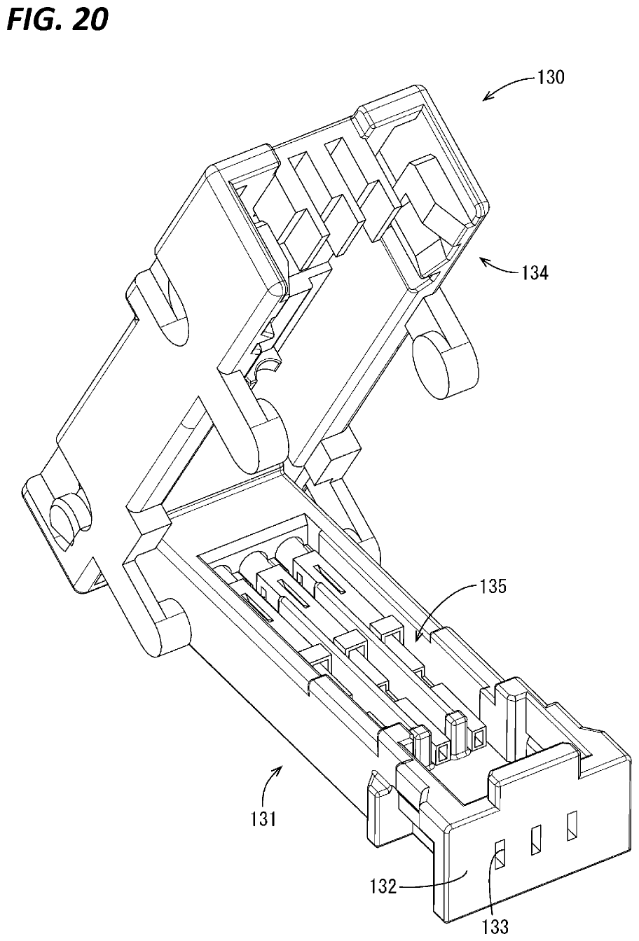

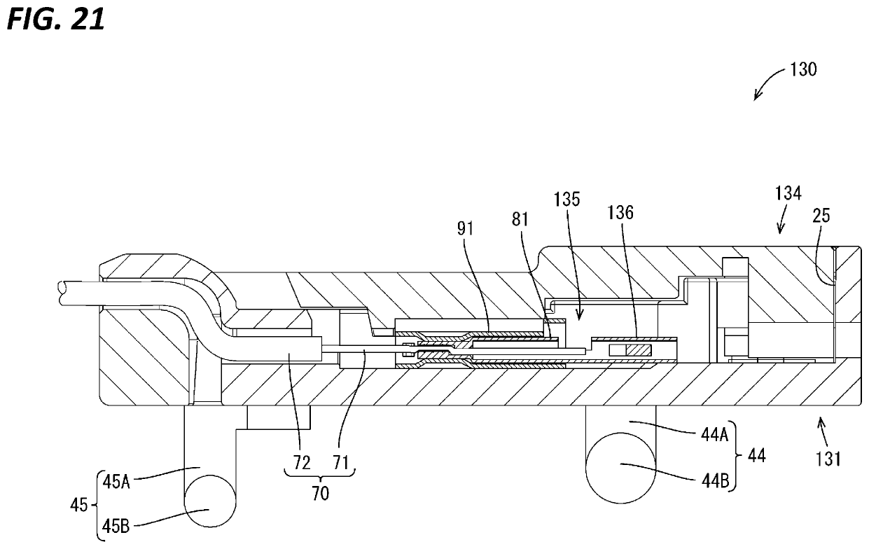

As shown in FIG. 19, the connector unit 120 is provided with a plurality of stacked sub-connectors 130 and a lock member 100 to be assembled with the sub-connector 130 located on an end, out of the plurality of these sub-connectors 130. As shown in FIGS. 20 and 21, the sub-connector 130 includes the plurality of female terminals 135, a plurality of wires 70 to be respectively connected to these female terminals 135, a lower housing 131 having an opening 25 and configured to accommodate the female terminals 135 and an upper cover 134 to be assembled with the lower housing 131 to close the opening 25.

As shown in FIG. 21, each female terminal 135 includes a terminal connecting portion 136 in the form of a rectangular tube capable of accommodating a tab of a mating male terminal inside, a terminal body 81 connected to the terminal connecting portion 136 and a slide member 91 to be assembled with the terminal body 81. The configurations of the terminal body 81 and the slide member 91 are similar to those of the embodiment.

Since the other configuration is the same as in the embodiment except details such as a front wall 132 of the lower housing 131 including terminal insertion holes 133, through which the tabs of the male terminals are inserted, similar components are denoted by the same reference signs and are not described. Also in this modification, functions and effects similar to those of the embodiment are achieved.

As just described, the terminals provided in the sub-connector 130 may be the female terminals 135. Alternatively, the terminals may be another type of terminals such as male terminals.

### Other Embodiments

(1) Although the one sub-connector 10 is held on the other sub-connector 10 also by the pair of fixing portions 44 in addition to the pair of movement restricting portions 45 in the above embodiment, the one sub-connector 10 may be held on the other sub-connector 10 only by the movement restricting portions. Alternatively, two or more pairs of the fixing portions 44 may be provided.

(2) Although the lower housing 20 includes the shaft portions 31 and the upper cover 40 includes the shaft holes 51 in the above embodiment, the upper cover 40 may include the shaft portions 31 and the lower housing 20 may include the shaft holes 51.

(3) Although the upper cover 40 is provided with the movement restricting portions 45 in the above embodiment, the lower housing 20 may be provided with the movement restricting portions 45.

### LIST OF REFERENCE NUMERALS

1, 120: connector unit
10, 130: sub-connector
10A: one sub-connector
10B: other sub-connector
20, 131: lower housing
21: bottom wall
22: inner side wall
22A: extended portion
23, 132: front wall
24: inner rear wall
25: opening
26: separation wall
27: cavity
28: coupling portion accommodating portion
29: first wire insertion hole
31: shaft portion
31A: first flat surface
31B: second flat surface
32: lower guide portion
32A: arcuate wall portion
32B: flat plate portion
33: first wire insertion groove
34: closing projection
35: slide guide
35A: thick portion
35B: thin portion
30, 134: upper cover
41: ceiling wall
42: outer side wall
43: outer rear wall
44: fixing portion
44A: fixing piece
44B: fixing protrusion
45: movement restricting portion
45A: restricting piece
45B: restricting protrusion
46: fixing grove
46A: first groove bottom surface
46B: first groove side surface
47: fixing recess
48: restricting groove
48A: second groove bottom surface
48B: second groove side surface
49: entrance groove
49A: third groove bottom surface
49B: third groove side surface
51: shaft hole
51A: rotation allowing portion
51B: rotation restricting portion
52A: first inner peripheral surface
52B: second inner peripheral surface
52C: third inner peripheral surface
52D: fourth inner peripheral surface
53: slide groove
54: temporary closing recess
55: complete closing recess
56: upper lock portion
57: wire lead-out opening
58: upper guide portion
59: second wire insertion groove
61: second wire insertion hole
70: wire
71: core wire
72: insulation coating
80: joint terminal (terminal)
81: terminal body
82: tube portion
83: upper sandwiching portion
84: lower sandwiching portion
85: upper sandwiching projection
86: lower sandwiching projection
87: intermediate portion
88: coupling portion
88A: bent portion
91: slide member
92: jig receiving portion
93: upper wall
93A: upper pressurizing portion
94: lower wall
94A: lower pressurizing portion
100: lock member
101: main wall
102: leg portion
103: lock arm
103A: arm body
103B: lock projection (lock portion)
104: deflection restricting portion
104A: coupling column
104B: interfering portion
105: fixing groove
106: fixing recess
110: mating member
111: receptacle
112: lock receiving portion
133: terminal insertion hole
135: female terminal (terminal)
136: terminal connecting portion
J: jig

1. A connector unit, comprising a plurality of coupled sub-connectors, wherein:
the sub-connector includes:
a terminal;
a lower housing having an opening, the lower housing accommodating the terminal; and
an upper cover to be assembled with the lower housing to close the opening,
the upper cover is slidable between a complete closing position for closing the entire opening and a temporary closing position shifted from the complete closing position and rotatable between the temporary closing position and an opening position for opening the opening,
one of the lower housing and the upper cover includes a rotation allowing portion for allowing rotation of the upper cover to the opening position when the upper cover is at the temporary closing position and a rotation restricting portion for restricting the rotation of the upper cover to the opening position when the upper cover is at the complete closing position, and
one sub-connector, out of the plurality of sub-connectors, includes a movement restricting portion for holding the one sub-connector inseparably from another sub-connector by being engaged with the other sub-connector and restricting a sliding movement of the upper cover provided in the other sub-connector from the complete closing position to the temporary closing position.

2. The connector unit of claim 1, wherein:
one of the upper cover and the lower housing includes a shaft portion and the other includes a shaft hole for receiving the shaft portion,
a part of the shaft hole serves as the rotation allowing portion for rotatably accommodating the shaft portion when the upper cover is at the temporary closing position and another part of the shaft hole serves as the rotation restricting portion for accommodating the shaft portion while restricting the rotation when the upper cover is at the complete closing position, and
the movement restricting portion of the one sub-connector is accommodated into the rotation allowing portion of the other sub-connector.

3. The connector unit of claim 1, further comprising a lock member to be assembled with the other sub-connector, wherein the lock member includes:
a lock arm having a lock portion to be engaged with a mating member, the lock arm being deflectable in a releasing direction for releasing engagement of the lock portion with the mating member; and
a deflection restricting portion connected to the lock arm, the deflection restricting portion restricting deflection of the lock arm in a direction opposite to the releasing direction by being engaged with the movement restricting portion provided in the other sub-connector.
